(19) United States
(12) Patent Application Publication
(10) Pub. No.: US 2022/0219719 A1
(43) Pub. Date: Jul. 14, 2022

(54) METHODS AND SYSTEMS FOR LOCATING A DYNAMIC OBJECT IN A FIELD OF KNOWN STATIC OBJECTS

(71) Applicant: James Stracka, Encinitas, CA (US)

(72) Inventor: James Stracka, Encinitas, CA (US)

(21) Appl. No.: 17/147,483

(22) Filed: Jan. 13, 2021

(51) Int. Cl. B60W 60/00; G01S 13/931

(52) U.S. Cl. CPC B60W 60/001; G01S 13/931; G01S 2013/9322; G01S 2013/932; B60W 2554/4049

(57) ABSTRACT

A computer-implemented method for locating a dynamic object in a field of known static objects, comprises steps of identifying a first static object in the field including a plurality of static objects, determining a first satellite navigation location of the first static object using a handheld device configured with a satellite navigation system, determining an offset value by comparing the first satellite navigation location with a first known location of the first static object, wherein the first known location of the first object is retrieved from a locations database containing location coordinates of the plurality of static objects, determining a dynamic satellite navigation location of a dynamic object using the handheld device and applying the offset value to the dynamic satellite navigation location of the dynamic object to determine a corrected dynamic location of the dynamic object.

### TECHNICAL FIELD

The present invention relates generally to methods and systems for tracking dynamic objects in real-time. More specifically, the present invention relates to systems and methods that can achieve a state of the art accuracy in the tracking and positioning of dynamic objects with the use of widely available and relatively economical devices.

### BACKGROUND ART

The real-time tracking and position of dynamic objects have had several applications in multifarious fields. Introduced first for reconnaissance and surveillance in national security missions, the technology has trickled down into peace-time applications such as logistics for real-time tracking of packages being delivered by autonomous or semi-autonomous vehicles (trucks and Unmanned Aerial Vehicles (UAVs)), autonomous vehicles used as public transport or for shared mobility, in sports, for tracking of balls or athletes, to ensure fair play, and even in the entertainment industry for the broadcast of events in a more immersive manner for the audiences attending the events remotely.

However, most of the technologies require massive capital investment for installation, involve rather extensive operational expenses, and the involvement of highly skilled personnel to manage and maintain such systems. One example of such a system is popularly known as Real-Time Kinematic Global Positioning System (RTK GPS) which is commonly used for defense purposes and in conducting government-funded surveys. However, because of the costs involved, such systems and technologies are not readily available to the general public, availability of which, would have otherwise made such location and positioning tracking to be used for everyday applications in minimizing wastages of finished or perishable goods, etc., reducing wait times in traffic situations or logistics, etc., relatively more accurate forecasts in small scale logistics applications and in several cases providing opportunities for them to be applied in enhancing user experience in leisure activities such as golf or paintball, etc.

Therefore, there is a need in the art for computer-implemented methods and computing systems for locating a dynamic object in a field of known static objects, which does not suffer from the aforementioned deficiencies.

### OBJECTS OF THE INVENTION

Some of the objects of the present invention are as follows:

An object of the invention is to provide systems and methods that can locate dynamic objects in a known environment with accuracy up to the order of centimeters.

Another object of the invention is to provide systems and methods that can achieve the desired accuracy with relatively widely available and economical devices.

Yet another object of the invention is to provide systems and methods that are capable of being deployed in both small scale logistics industries and leisure activities.

Also, another object of the invention is to provide systems and methods that do not require massive operational expenditures and highly skilled personnel to keep the systems and the methods functional and operative.

### SUMMARY

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art.

According to a first aspect of the present invention, there is provided a computer-implemented method for locating a dynamic object in a field of known static objects, the computer-implemented method comprising steps of identifying a first static object in the field including a plurality of static objects, determining a first satellite navigation location of the first static object using a handheld device configured with a satellite navigation system, determining an offset value by comparing the first satellite navigation location with a first known location of the first static object, wherein the first known location of the first object is retrieved from a locations database containing location coordinates of the plurality of static objects, determining a dynamic satellite navigation location of a dynamic object using the handheld device and applying the offset value to the dynamic satellite navigation location of the dynamic object to determine a corrected dynamic location of the dynamic object. Further, the first known location of the first object is at least one hundred times more accurate than the first satellite navigation location of the first static object.

In one embodiment of the invention, the computer-implemented method further comprises a step of determining a second satellite navigation location of a second static object and retrieving a second known location of the second static object from the locations database. Further, the offset value is determined as a function of a first offset determined from comparing the first satellite navigation location with the first known location, and a second offset determined from comparing the second satellite navigation location with the second known location.

In one embodiment of the invention, the offset value is one or more of a simple mean of the first offset and the second offset, a weighted mean of the first offset and the second offset, and a root mean square value determined from the first offset and the second offset.

In one embodiment of the invention, the computer-implemented method further comprises a step of determining a distance between the dynamic object and a target static object in the field.

In one embodiment of the invention, the distance is determined by the handheld device by comparing the corrected dynamic location of the dynamic object with a target known location, corresponding to the target object, retrieved from the locations database.

According to a second aspect of the present invention, there is provided a computing system for locating a dynamic object in a field of known static objects, the computing system comprising one or more processors, one or more memory unit including machine-readable instructions that when executed by the one or more processors, enable the one or more processors to identify a first static object in the field including a plurality of static objects, determine a first satellite navigation location of the first static object using a handheld device configured with a satellite navigation system, determine an offset value by comparing the first satellite navigation location with a first known location of the first static object, wherein the first known location of the first object is retrieved from a locations database containing location coordinates of the plurality of static objects, determine a dynamic satellite navigation location of a dynamic object using the handheld device and apply the offset value to the dynamic satellite navigation location of the dynamic object to determine a corrected dynamic location of the dynamic object. Further, the first known location of the first object is at least one hundred times more accurate than the first satellite navigation location of the first static object.

In one embodiment of the invention, the one or more processors are further enabled to determine a second satellite navigation location of a second static object and retrieving a second known location of the second static object from the locations database. Further, the offset value is determined as a function of a first offset determined from comparing the first satellite navigation location with the first known location, and a second offset determined from comparing the second satellite navigation location with the second known location.

In one embodiment of the invention, the offset value is one or more of a simple mean of the first offset and the second offset, a weighted mean of the first offset and the second offset, and a root mean square value determined from the first offset and the second offset.

In one embodiment of the invention, the one or more processors are further configured to determine a distance between the dynamic object and a target static object in the field.

In one embodiment of the invention, the distance is determined by the handheld device by comparing the corrected dynamic location of the dynamic object with a target known location, corresponding to the target object, retrieved from the locations database.

According to a third aspect of the present invention, a computer-implemented method is provided. The method comprises, identifying, by a processor on a handheld device, a first static object in a field of known static objects; determining, by the processor on the handheld device, a first satellite navigation location of the first static object, the handheld device configured with a satellite navigation system; determining, by the processor on the handheld device, an offset value by comparing the first satellite navigation location with a first known location of the first static object, wherein the first known location of the first static object is retrieved from a locations database containing location coordinates of the plurality of static objects; determining, by the processor on the handheld device, a dynamic satellite navigation location of a dynamic object using the handheld device; and applying, by the processor on the handheld device, the offset value to the dynamic satellite navigation location of the dynamic object to determine a corrected dynamic location of the dynamic object.

In one embodiment of the invention, the computer-implemented method further comprises determining, by the processor on the handheld device, a second satellite navigation location of a second static object and retrieving a second known location of the second static object from the locations database; wherein the offset value is determined as a function of: a first offset determined from comparing the first satellite navigation location with the first known location; and a second offset determined from comparing the second satellite navigation location with the second known location.

In one embodiment of the invention, the offset value is one or more of a simple mean of the first offset and the second offset, a weighted mean of the first offset and the second offset, and a root mean square value determined from the first offset and the second offset.

In one embodiment of the invention, the computer-implemented method further comprises determining, by the processor on the handheld device, a distance between the dynamic object and a target static object in the field.

The following detailed description is illustrative and is not intended to be in any way limiting. In addition to the illustrative aspects, embodiments, and features described above, further aspects, embodiments, and features will be apparent by reference to the following detailed description in conjunction with the accompanying drawings.

### BRIEF DESCRIPTION OF DRAWINGS

So that the manner in which the above-recited features of the present invention can be understood in detail, a more particular description of the invention, briefly summarized above, may have been referred by examples, some of which are illustrated in the appended drawings. It is to be noted, however, that the appended drawings illustrate only typical examples of this invention and are therefore not to be considered limiting of its scope, for the invention may admit to other equally effective examples.

These and other features, benefits, and advantages of the present invention will become apparent by reference to the following text figure, with like reference numbers referring to like structures across the views, wherein:

FIG. 1 illustrates an exemplary golf course environment to which several embodiments of the present invention may be implemented;

FIG. 2 illustrates a computing system of computing devices for locating a dynamic object in a field of known static objects, in accordance with an embodiment of the present invention;

FIG. 3 illustrates a block diagram representation of an example hardware implementation of a handheld device, in accordance with an embodiment of the present invention;

FIG. 4 illustrates a block diagram representation of an example hardware implementation for an application server, in accordance with an embodiment of the present invention;

FIG. 5 illustrates a computer-implemented method for locating a dynamic object in a field of known static objects, in accordance with an embodiment of the invention; and

FIG. 6 illustrates a topographical map of the golf course of FIG. 1.

### DETAILED DESCRIPTION

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims.

### Terms and Definitions

As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,’ “comprising,” “having,” “containing,” or “involving,” and variations thereof, is intended to be broad and encompass the subject matter listed thereafter, equivalents, and additional subject matter not recited, and is not intended to exclude other additives, components, integers, or steps. Likewise, the term “comprising” is considered synonymous with the terms “including” or “containing” for applicable legal purposes. Any discussion of documents, acts, materials, devices, articles, and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element, or group of elements with transitional phrases “consisting of”, “consisting”, “selected from the group of consisting of”, “including”, or “is” preceding the recitation of the composition, element or group of elements and vice versa. The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. Also, several materials are identified as suitable for various facets of the implementations. These materials are to be treated as exemplary and are not intended to limit the scope of the invention.

The term “computer-readable medium” as used herein refers to any tangible storage that participates in providing instructions to a processor for execution. That is, the term “computer-executable instruction” is considered to include a set of instructions that is capable of being executed or run as a program in the computing device. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “central processing unit”, “processor”, “processor circuit”, and “processing circuit”, and variations thereof, as used herein, are used interchangeably and include, but are not limited to, a general purpose processor, a digital signal processor (DSP), an ARM-based processor, an application-specific integrated circuit (ASIC), a field programmable gate array (FPGA) or other programmable logic component, discrete gate or transistor logic, discrete hardware components, or any combination thereof designed to perform the functions described herein. A general-purpose processor may include a microprocessor, as well as any conventional processor, controller, microcontroller, or state machine. The processor may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processors are for illustration and other suitable configurations within the scope of the disclosure are also contemplated. Furthermore, the processor may be implemented as one or more processors, one or more controllers, and/or other structure configured to execute executable programming.

In the context of the specification, the term “memory unit” is considered to be inclusive of volatile memory units such as Static Random-Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the term “application server” is considered to be a software framework that delivers contents, assets, and respond to the request made by client program which may include web-based applications, browsers, and mobile apps. An application server facilitates the hosting and delivery of high-end consumer or business applications, which are used by multiple and simultaneously connected local or remote users.

In the context of the specification, the term “transceiver” is considered to be a device that is able to both transmit and receive information through a transmission medium. A transceiver is a combination transmitter/receiver in a single package. The term applies to wireless communications devices such as cellular telephones, cordless telephone sets, handheld two-way radios, and mobile two-way radios.

In the context of the specification, the term “communication interface” is considered to include ports such as Universal Serial Bus (USB) port, Video Graphics Array (VGA) port, and High-Definition Multimedia Interface (HDMI) port for wired connections. The communication interface may also include modems for wireless communication, such as a Wireless Fidelity (Wi-Fi) modem for data transfer or a GSM modem for mobile telephony, and GPRS modems for connecting to the Internet or other Wide Area Networks through protocols standardized by 3GPP.

In the context of the specification, the term “communication network” is considered to be inclusive of Local Area Networks (LANs) be implemented through several short-range wired or wireless communication protocols such as Ethernet, ZigBee, Bluetooth, Wireless Fidelity (Wi-Fi), and Near Field Communication (NFC), etc. and Wide Area Networks (WANs) implemented through protocols standardized by the 3^{rd} Generation Partnership Project, such as HSPA, HSDPA, LTE, and the like or through protocols standardized by IEEE such as 802.11 Wi-Fi and 802.3 Ethernet or the like. The communication networks may be any one or combination of two or more communication networks such as, but not limited to, the just-mentioned communication networks.

In The terms “determine,” “calculate,” and “compute,” and variations thereof, as used herein, are used interchangeably and include any type of methodology, process, mathematical operation or technique.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The term “handheld device” as used herein may include, without limitation, laptops, tablets, cellular phones, mobile devices, and Personal Digital Assistants (PDAs).

The term “module” as used herein refers to any known or later developed hardware, software, firmware, artificial intelligence, fuzzy logic, or combination of hardware and software that is capable of performing the functionality associated with that element.

### Overview

A method locating a dynamic object in a field of known static objects has been explained with the help of an exemplary golf course environment. While the present invention is described primarily with respect to a golf course, the present invention may be applied and adapted to various applications. A person skilled in the art would appreciate that the invention is not limited to the golf course environment alone, maybe equivalently be implemented in several other environments such as for reconnaissance, land area development planning, and building of huge compounds such as hospitals and schools which are distributed over a large plot of land, etc. Also, a variety of other embodiments are contemplated having different combinations of the below described features of the present invention, having features other than those described herein, or even lacking one or more of those features. As such, it is understood that the invention can be carried out in various other suitable modes.

It is envisaged that the invention is implemented using widely available and economical electronic devices configured for satellite navigation to achieve several times more accuracy in location and positioning than the accuracy that can be achieved from conventionally available devices with satellite navigation used for traveling over longer distances. The present invention involves the use of a locations database that may be generated using a highly accurate location and positioning systems and then using that locations database to improve the accuracy of the conventional electronic devices, thereby requiring only one time relatively higher expenditure for generating the locations database and then working the invention with relatively minimal operational expenditures. Referring to the figures, the invention will be described in further detail.

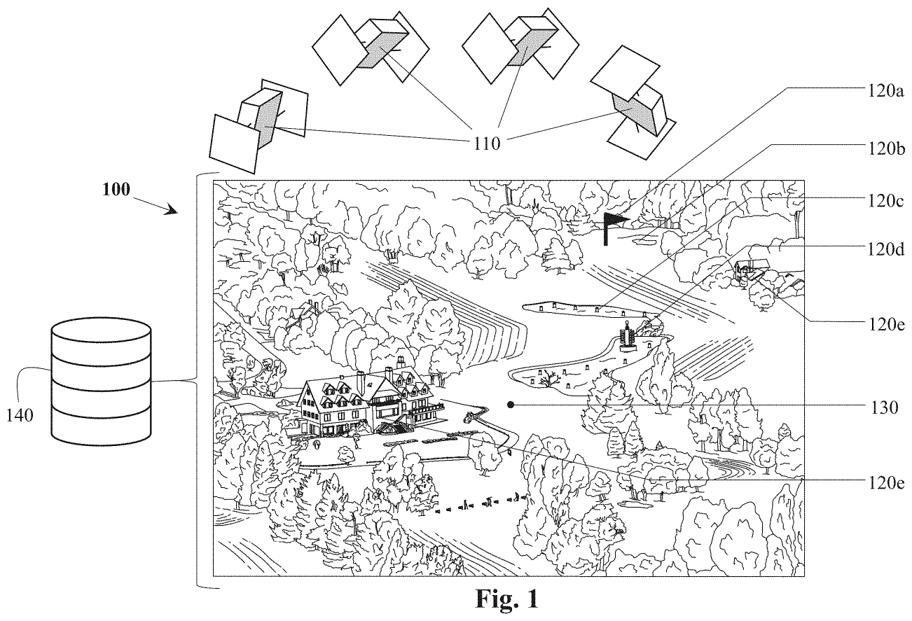

FIG. 1 illustrates an exemplary golf course environment 100 to which several embodiments of the present invention may be implemented. The exemplary golf course environment 100 includes a plurality of static objects 120, such as but not limited to, a flag-post 120a indicating the location of a hole, a plurality of bunkers 120b, a plurality of ponds 120c, a plurality of sprinklers 120d, a plurality of building structures 120e, amongst the greens, roughs, tee-locations and the fairways. It is further envisaged that a specific locator element is provided in each one of the plurality of static objects 120. For example, the plurality of ponds 120c may be provided with a plurality of respective buoys, the plurality of bunkers 120b may be provided with a plurality of respective locator slabs made out of concrete or metal, and the plurality of building structures 120e may be provided with a plurality of respective mastheads, etc. The plurality of locator elements in that regard may be used to assign a location value to the plurality of static elements 120. It is to be noted here that the plurality of static elements 120 is envisaged to not change their location over a predetermined, relatively longer period. However, the exact duration of that period may vary from one application to another.

The exemplary golf course environment 100 also includes a dynamic object 130 that is envisaged to be a golf ball in this case, since the location of the golf ball, when compared to the plurality of static elements 120 changes much more frequently. It is further envisaged that the golf course environment 100 is within access to a satellite navigation system including a plurality of satellites 110. Even, one of the most popular satellite navigation systems is the Global Positioning System (GPS), the present invention is not limited to the GPS alone, but may also be implemented with other equivalent satellite navigation systems such as the Global Navigation Satellite System (GLONASS) of Russia, the BeiDou Navigation Satellite System (BDS) of China, the Galileo of European Union, Quasi-Zenith Satellite System (QZSS) of Japan and Indian Regional Navigation Satellite System (IRNSS) of India.

There is also provided a locations database 140 associated with the golf course environment 100 that includes location coordinates of the plurality of static objects 120. It is further envisaged that the location coordinates, the plurality of static objects 120, stored in the locations database are at least one hundred times more accurate than the location coordinates, the plurality of static objects 120, determined from the satellite navigation system. This feature is highly desirable for transforming the accuracy of rough 0.5 m to 1 m obtained from the satellite navigation system to the accuracy in the order of 1 cm or less, required in the golf course environment 100. However, the level of accuracy may vary from one application to another.

However, to generate the locations database 140, a relatively more accurate and state of the art systems for locating and positioning may initially be required. Such positioning systems generally involve the use of lasers and may require ground-based or airborne laser scanning and topographical maps generation. For example, techniques within the purview of Terrestrial Laser Scanning (TLS) or Terrestrial Light Detection and Ranging (Terrestrial LiDAR) can achieve accuracies of up to 0.1 cm. Real Time Kinematic-Global Navigation Satellite Systems (RTK GNSS) can achieve accuracies in the order of millimeters. More information on the same can be found in Reynolds, W., Young, F., and Gibbings, P. (2005). A comparison of methods for mapping golf greens. Spatial Science Queensland, 4, 33-36, and Bueno, M. V., A. D. S. de Campos, J. T. da Silva, L. C. Faria, F. da Silva Terra, and J. M. B. Parfitt. 2019. “Demarcation of levees in irrigated rice fields: Laser technology vs. GNSS-RTK”, Applied Engineering in Agriculture. 35(3): 431-437. (DOI: 10.13031/aea.13012). The two aforementioned cited references are included herein by reference, in their entirety.

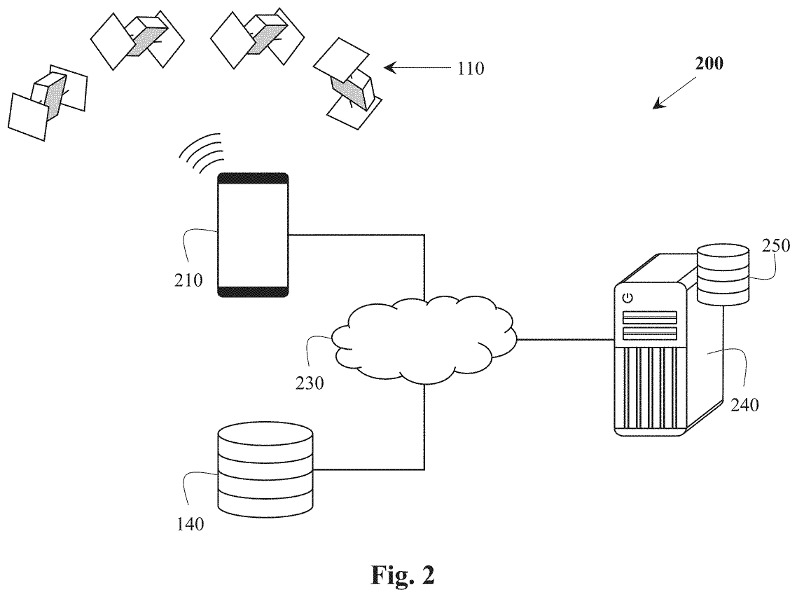

FIG. 2 illustrates a computing system 200 of computing devices for locating the dynamic object 130 in a field of known static objects 120, in accordance with an embodiment of the present invention. The computing system 200 includes a handheld device 210 configured with the satellite navigation system corresponding to the plurality of satellites 110. The handheld device 210 in that regard may be a smartphone, a tablet computer, a Personal Digital Assistant (PDA), or a dedicated navigation device designed specifically for the concerned application. In any case, the handheld device 210 is envisaged to include a processor, a memory unit, and a communication interface allowing the handheld device 210 to be able to communicate with other computing devices over a communication network 230. Also, connected to the communications network 230 is the locations database 140.

An application server 240 and a storage device 250 are also connected to the communication network 230. The application server 240 is also envisaged to include computing hardware such as a processor, a memory unit and a communication interface, and software/firmware in form of machine-readable instructions to enable the processor for performing several computing steps involved in the present invention. A person skilled in the art would appreciate that the application server 240 may be a remote server, a local server, or a cloud-based server. In several alternate embodiments of the invention, the functionalities of the application server 240 and the storage device 250 may also be embedded within the handheld device 210, without departing from the scope of the invention. In any scenario, the working of the present invention would include one or more processors executing machine-readable instructions to achieve the aforementioned objectives of the invention

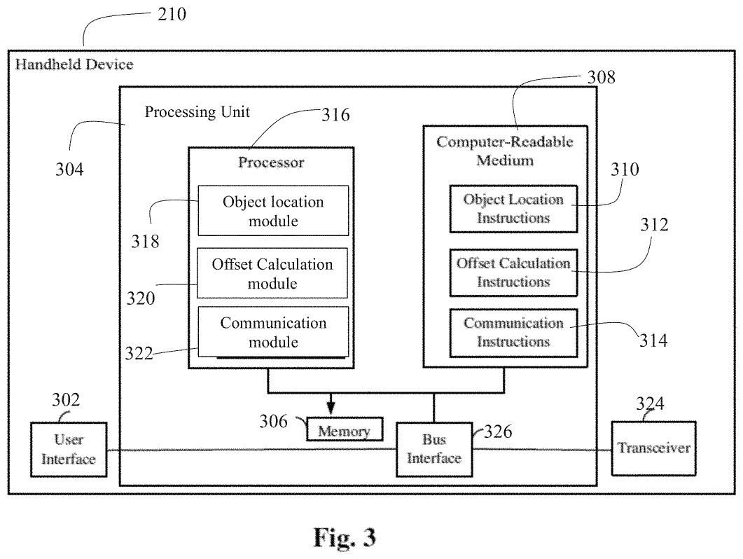

FIG. 3 illustrates a block diagram representation of an example hardware implementation a handheld device 210 for locating the dynamic object 130 in a field of known static objects 120, in accordance with an embodiment of the present invention. The handheld device 210 may include a user interface 302 through which a user interacts with the computing system 200 of the present invention. Depending upon the nature of the handheld device 210, the user interface 302 (e.g., keypad, display, speaker, microphone, joystick) is optional and may be omitted in some examples. The handheld device 210 may further include a processing unit 304 that processes computer-readable media (represented generally by the computer-readable medium or program 308) stored in the memory unit 306 of the handheld device 210. The computer-readable medium or program 308 includes a set of computer-executable instructions that performs the functions or task as desired by a user to locate the dynamic object in a field of a known static object. The computer-executable instruction may include, but are not limited to, object location instructions 310, offset value calculation instruction 312, and instructions related to further communication e.g., communications instructions 314. The object location instructions 310 as shown in FIG. 3 compiles a set of instructions that are performed by the processing unit 304 during the identification process of objects including both dynamic 130 and static objects 120. The offset value calculation instructions 312 compiles a set of instructions that are performed by the processing unit 304 when the satellite navigation location of the static object 120 is compared with the known location of the same static object 120 stored in the location database 140.

The processing unit 304 is further envisaged to include a processor 316 comprising an object location module 318 that processes the object location instruction 310 in order to identify the location coordinates of both static 120 and dynamic object 130, an offset calculation module 320, where the offset value calculation instructions 312 are processed by comparing the satellite navigation location of static object 120 with the known location (stored in the database 140) of that static object 120. And a communication module 322 is also provided in the processor 316, which is adapted to transmit information between the processor 316 and computer-readable medium or program 308. The handheld device 210 is further envisaged to include a transceiver unit 324 that is configured to transmit and receive information between the handheld device 210 and other apparatus and computing devices over a transmission medium, and a communication interface preferably a bus interface 326 that allows the transmission of data between the internal components of the handheld device 210.

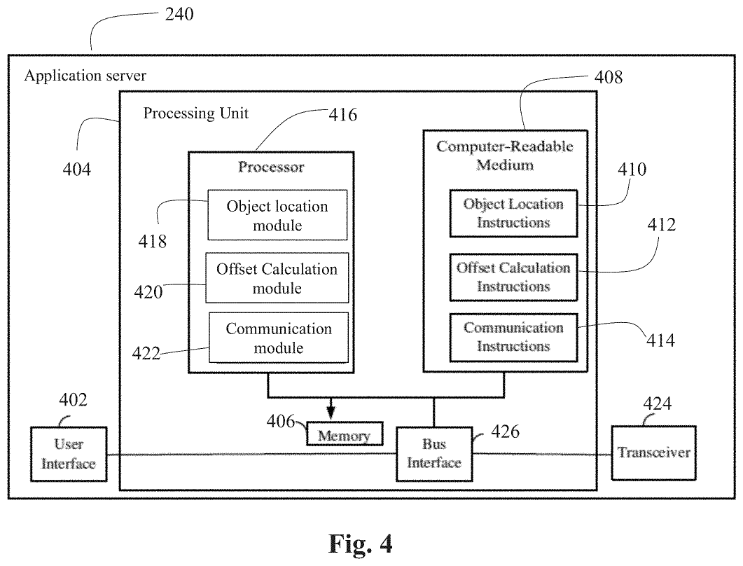

FIG. 4 illustrates a block diagram representation of an example hardware implementation for an application server 240 for locating the dynamic object 130 in a field of known static objects 120, in accordance with an embodiment of the present invention. The application server 240 is a mixed framework of software that allows both the creation of web applications and a server environment to run them. In the present invention, the application server 240 accepts and responds to the request made by the client application or server stored in the handheld device 210. The application server 240 includes a user interface 402 through which a user interacts with the computing system 200 of the present invention, a processing unit 404 that processes a computer-readable medium or program 408 stored in the memory unit 406 of application server 240. The computer-readable medium or program 408 includes a set of computer-executable instructions that performs the functions or task as desired by a user to locate the dynamic object 130 in a field of a known static object 120. The computer-executable instruction may include but not limited to object location instructions 410, offset value calculation instruction 412, and instructions related to further communication e.g. communications instructions 414. The object location instructions 410 as shown in FIG. 3 compiles a set of instructions that are performed by the processing unit 404 during the identification process of objects including both dynamic object 130 and static objects 120. The offset value calculation instructions 412 compiles a set of instructions that are performed by the processing unit 404 when the satellite navigation location of the static object 120 is compared with the known location of the same static object 120 stored in the location database 140.

The processing unit 404 is further envisaged to include a processor 416 comprising an object location module 418 that processes the object location instruction 410 in order to identify the location coordinates of both static 120 and dynamic object 130, an offset calculation module 420, where the offset value calculation instructions 412 are processed by comparing the satellite navigation location of static object 120 with the known location (stored in the database 140) of that static object 120. And a communication module 422 is also provided in the processor 416, which is adapted to transmit information between the processor 416 and computer-readable medium or program 408. The application server 240 is further envisaged to include a transceiver unit 424 that is configured to transmit and receive information between the application server 240 and other computing devices, and a communication interface preferably a bus interface 426 that allows the transmission of data between the internal components of the application server 240.

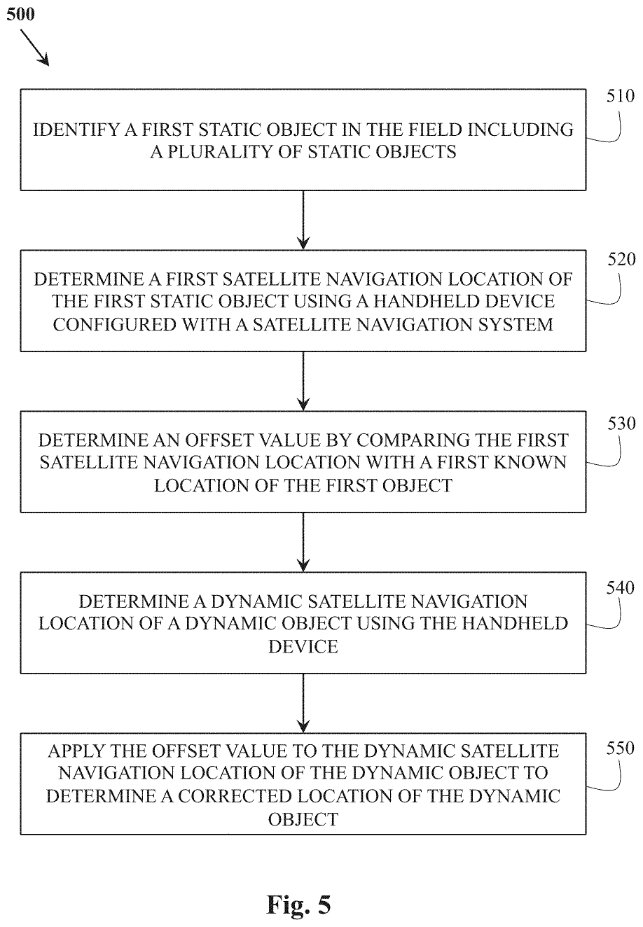

FIG. 5 illustrates a computer-implemented method 500 for locating a dynamic object 130 in a field of known static objects 120, in accordance with an embodiment of the present invention. The computer implement method 500 begins at step 510 when a processor of the handheld device 210 identifies a first static object in the field including a plurality of static objects 120. The identification may be enabled by a user moving to a static object, such as one of the plurality of sprinklers 120d. At step 520, the processor then determines the first satellite navigation location of the first static object 120d using the satellite navigation system configured with the handheld device 210. The first satellite navigation location may include a latitude coordinate and a longitude coordinate. At step 530, the processor (from the handheld device 210 or the application server 240) determines an offset value by comparing the first satellite navigation location with the first known location of the first static object 120d.

The first known location of the first static object 120d is retrieved from the locations database 140. Moreover, the offset value is indicative of the error in the first satellite navigation location. At step 540, the processor of the handheld device 210 determines a dynamic satellite navigation location of the dynamic object 130 using the handheld device 210. The dynamic object 130 in this case is the golf ball, the user would then move to the golf ball. At step 550, the processor, of the handheld device 210 or the application server 240, applies the offset value to the dynamic satellite navigation location of the dynamic object 130 to determine a corrected dynamic location of the dynamic object 130. The corrected dynamic location of the dynamic object 130 is envisaged to be at least a hundred times more accurate than the dynamic satellite navigation location.

In several alternate embodiments of the invention, the processor utilizes more than one static object, from the plurality of static objects 120, to determine the offset value. For example, the user may then move from the sprinkler 120d to a building structure 120e, or another sprinkler 120d. The processor also determines a second satellite navigation location of a second static object (the building structure 120e) and retrieves a second known location of the second static object 120e, from the locations database 140. Then the processor determines a first offset from comparing the first satellite navigation location with the first known location, and a second offset determined from comparing the second satellite navigation location with the second known location. The offset value, in that regard, is calculated as a function of the first offset and the second offset. For example, the offset value may be one or more of a simple mean of the first offset and the second offset, a weighted mean of the first offset and the second offset, and a root mean square value determined from the first offset and the second offset.

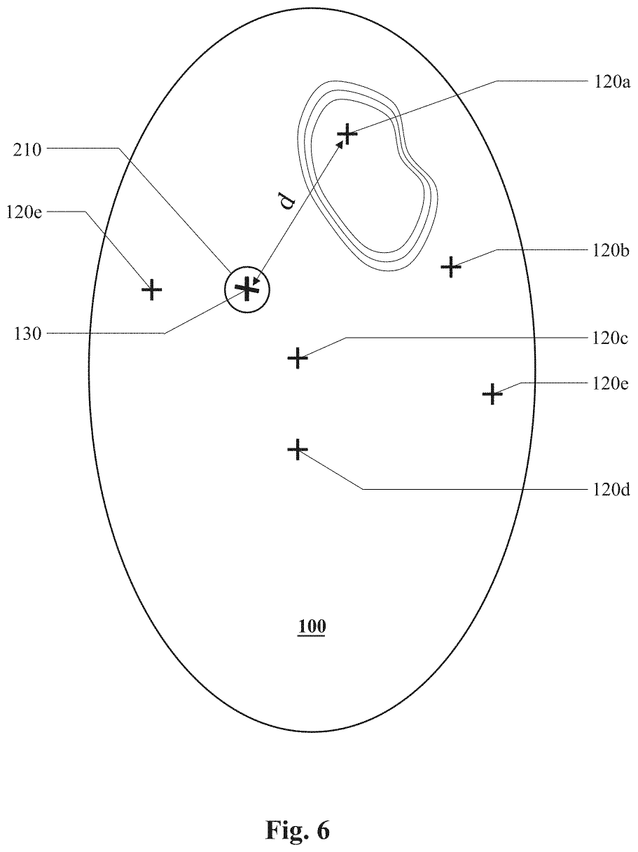

Once the corrected dynamic location of the dynamic object 130 is known, the handheld device 210 may be used to determine a distance between the dynamic object 130 and a target static object in the field. In this scenario, the target static object may be the flag post 120a indicating the location of the hole. FIG. 6 illustrates a topographical map of the golf course 100 of FIG. 1. The distance, denoted by the letter ‘d’, is determined by the handheld device 210 by comparing the corrected dynamic location of the dynamic object 130 with a target known location, corresponding to the target object (the flag post 120a in this case), retrieved from the locations database 140. The distance may also be measured using the measuring tape

### Example 1

The location coordinates of the flag post 120a were stored in the locations database 140 as (200, 700), and the dynamic satellite location of the dynamic object 130 was determined to be (123, 678). The offset value previously determined was (−23, −78). Therefore, the corrected dynamic location of the dynamic object 130 was calculated to be (100, 600). Therefore, applying simple mathematics, the distance between the dynamic objection 130 (the golf ball) and the flag post 120a was calculated as below.

d=\sqrt{(700−600)²+(200−100)²}=141.4214

### CONCLUSION

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. The terms “at least one” and “one or more” may be used interchangeably herein.

One or more of the components, steps, features and/or functions illustrated herein may be rearranged and/or combined into a single component, step, feature, or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing broadest scope consistent with the principles and the novel and inventive features disclosed or suggested herein. Accordingly, the invention is anticipated to hold on to all other such alternatives, modifications, and variations that fall within the scope of the present invention and appended claims.

1. A computer-implemented method for locating a dynamic object in a field of known static objects, the computer-implemented method comprising steps of:
identifying a first static object in the field including a plurality of static objects;
determining a first satellite navigation location of the first static object using a handheld device configured with a satellite navigation system;
determining an offset value by comparing the first satellite navigation location with a first known location of the first static object, wherein the first known location of the first static object is retrieved from a locations database containing location coordinates of the plurality of static objects;
determining a dynamic satellite navigation location of a dynamic object using the handheld device; and
applying the offset value to the dynamic satellite navigation location of the dynamic object to determine a corrected dynamic location of the dynamic object.

2. The computer-implemented method as claimed in claim 1, further comprising a step of:
determining a second satellite navigation location of a second static object and retrieving a second known location of the second static object from the locations database;
wherein the offset value is determined as a function of:
a first offset determined from comparing the first satellite navigation location with the first known location; and
a second offset determined from comparing the second satellite navigation location with the second known location.

3. The computer-implemented method as claimed in claim 2, wherein the offset value is one or more of a simple mean of the first offset and the second offset, a weighted mean of the first offset and the second offset, and a root mean square value determined from the first offset and the second offset.

4. The computer-implemented method as claimed in claim 1, further comprising a step of determining a distance between the dynamic object and a target static object in the field.

5. The computer-implemented method as claimed in claim 4, wherein the distance is determined by the handheld device by comparing the corrected dynamic location of the dynamic object with a target known location, corresponding to the target static object, retrieved from the locations database.

6. The computer-implemented method as claimed in claim 1, wherein the first known location of the first static object is at least one hundred times more accurate than the first satellite navigation location of the first static object.

7. A computing system for locating a dynamic object in a field of known static objects, the computing system comprising:
one or more processors;
one or more memory unit communicatively, coupled to the one or more processors, having machine-readable instructions that when executed by the one or more processors, enable the one or more processors to:
identify a first static object in the field including a plurality of static objects;
determine a first satellite navigation location of the first static object using a handheld device configured with a satellite navigation system;
determine an offset value by comparing the first satellite navigation location with a first known location of the first static object, wherein the first known location of the first static object is retrieved from a locations database containing location coordinates of the plurality of static objects;
determine a dynamic satellite navigation location of a dynamic object using the handheld device; and
apply the offset value to the dynamic satellite navigation location of the dynamic object to determine a corrected dynamic location of the dynamic object.

8. The computing system as claimed in claim 7, wherein the one or more processors are further enabled to:
determine a second satellite navigation location of a second static object and retrieving a second known location of the second static object from the locations database;
wherein the offset value is determined as a function of:
a first offset determined from comparing the first satellite navigation location with the first known location; and
a second offset determined from comparing the second satellite navigation location with the second known location.

9. The computing system as claimed in claim 8, wherein the offset value is one or more of a simple mean of the first offset and the second offset, a weighted mean of the first offset and the second offset, and a root mean square value determined from the first offset and the second offset.

10. The computing system as claimed in claim 7, wherein the one or more processors are further configured to determine a distance between the dynamic object and a target static object in the field.

11. The computing system as claimed in claim 10, wherein the distance is determined by the handheld device by comparing the corrected dynamic location of the dynamic object with a target known location, corresponding to the target static object, retrieved from the locations database.

12. The computing system as claimed in claim 7, wherein the first known location of the first static object is at least one hundred times more accurate than the first satellite navigation location of the first static object.

13. A computer-implemented method, comprising:
identifying, by a processor on a handheld device, a first static object in a field of known static objects;
determining, by the processor on the handheld device, a first satellite navigation location of the first static object, the handheld device configured with a satellite navigation system;
determining, by the processor on the handheld device, an offset value by comparing the first satellite navigation location with a first known location of the first static object, wherein the first known location of the first static object is retrieved from a locations database containing location coordinates of the plurality of static objects;
determining, by the processor on the handheld device, a dynamic satellite navigation location of a dynamic object using the handheld device; and
applying, by the processor on the handheld device, the offset value to the dynamic satellite navigation location of the dynamic object to determine a corrected dynamic location of the dynamic object.

14. The computer-implemented method of claim 13, further comprising:
determining, by the processor on the handheld device, a second satellite navigation location of a second static object and retrieving a second known location of the second static object from the locations database;
wherein the offset value is determined as a function of:
a first offset determined from comparing the first satellite navigation location with the first known location; and
a second offset determined from comparing the second satellite navigation location with the second known location.

15. The computer-implemented method of claim 14, wherein the offset value is one or more of a simple mean of the first offset and the second offset, a weighted mean of the first offset and the second offset, and a root mean square value determined from the first offset and the second offset.

16. The computer-implemented method of claim 13, further comprising determining, by the processor on the handheld device, a distance between the dynamic object and a target static object in the field.
